(19) United States
(12) Patent Application Publication
(10) Pub. No.: US 2011/0161084 A1
(43) Pub. Date: Jun. 30, 2011

(54) APPARATUS, METHOD AND SYSTEM FOR GENERATING THRESHOLD FOR UTTERANCE VERIFICATION

(75) Inventors: Cheng-Hsien Lin, Taipei County (TW); Sen-Chia Chang, Hsinchu City (TW); Chi-Tien Chiu, Nantou County (TW)

(73) Assignee: INDUSTRIAL TECHNOLOGY RESEARCH INSTITUTE, Hsinchu (TW)

(21) Appl. No.: 12/822,188

(22) Filed: Jun. 24, 2010

(30) Foreign Application Priority Data
Dec. 29, 2009 (TW) 98145666

(51) Int. Cl. G10L 15/00

(52) U.S. Cl. 704/252; 704/E15.004

(57) ABSTRACT

Apparatus, method and system for generating a threshold for utterance verification are introduced herein. When a processing object is determined, a recommendation threshold is generated according to an expected utterance verification result. In addition, extra collection of corpuses or training models is not necessary for the utterance verification introduced here. The processing unit can be a recognition object or an utterance verification object. In the apparatus, method and system for generating a threshold for utterance verification, at least one of the processing objects is received and then a speech unit sequence is generated therefrom. One or more values corresponding to each of the speech unit of the speech unit sequence are obtained accordingly, and then a recommendation threshold is generated based on an expected utterance verification result.

### CROSS-REFERENCE TO RELATED APPLICATION

This application claims the priority benefit of Taiwan application serial no. 98145666, filed on Dec. 29, 2009. The entirety of the above-mentioned patent application is hereby incorporated by reference herein and made a part of this specification.

### BACKGROUND

### Technical Field

The disclosure is related to an apparatus and a method for generating a threshold for utterance verification which are suitable for a speech recognition system.

An utterance verification function is an indispensible part of a speech recognition system and is capable of effectively preventing mistaken recognition actions from occurring caused by out-of-vocabulary terms. In current utterance verification algorithms, after an utterance verification score is calculated and obtained therefrom, the score is compared with a threshold. If the score is greater than the threshold, utterance verification is successful; conversely, utterance verification fails. During actual application, an optimal threshold may be obtained by collecting more and more corpuses and analyzing an expected utterance verification result. Most solutions obtain the utterance verification result by using such a framework.

Referring to FIG. 1A, a conventional speech recognition system includes a speech recognition engine 110 and an utterance verificator 120. When a speech command is received, for example a request to turn on a television set, to play a movie, or to play music, or when a undefined command, for example a command for controlling a lamp or a game is received, the speech recognition engine 110 renders a judgment according to a recognition command set 112 and a acoustic model 114. The recognition command set 112 is built for the requested actions of the television set, playing the movie, or playing music, and the acoustic model 114 provides a model set established for the commands for the above actions to the speech recognition engine 110 as a basis for judgment. The recognition result is output to the utterance verificator 120, and a confidence score is obtained through calculation. The confidence score corresponding to the speech input is compared with a threshold, as the judgment step shown by the reference numeral 130. When the confidence score is greater than the threshold, that is, the request in the speech input is verified belonging to a command in the recognition command set 112, a corresponding action is performed, such as turning on the television set, playing the movie, or playing music. However, if the request in input speech is verified not belonging to a command in the recognition command set 112, for example requesting operation of the lamp or the game, no corresponding action is performed.

Please refer to FIG. 1B for the generation of the threshold. The optimal threshold is generated through referring to the commands in the recognition command set, collecting massive amounts of speech data, and analyzing the above. For example, a command set 1 is used to generate an optimal threshold 1 and a command set 2 is used to generate an optimal threshold 2. Large amounts of manual labor is required for inputting the above speech data, and when the recognition term set changes, the task must redone. In addition, when the threshold that is originally configured is not as expected, the user may manually configure the threshold as shown in FIG. 1C. The value of the threshold may be adjusted until a satisfying value is determined.

The above method limits the application range of the speech recognition system, so that the practical value thereof is greatly reduced. For example, if the speech recognition system is used in an embedded system such as in a system-on-a-chip (SoC) configuration, a method for adjusting the threshold cannot be included due to consideration of costs, so that the above problem must be resolved. As shown in FIG. 2, for example, after an integrated circuit (IC) supplier provides an integrated circuit which has a speech recognition function to a system manufacturer, the system manufacturer integrates the integrated circuit with the speech recognition function into the embedded system. Under such a framework, unless the integrated circuit supplier adjusts the threshold and re-supplies the circuit to the system manufacturer, the threshold may not be adjusted by the system manufacturer or the user.

Many patents, such as the following, are related to utterance verification systems and provide discussion on how to adjust the threshold.

U.S. Pat. No. 5,675,706 provides “Vocabulary Independent Discriminative Utterance Verification For Non-Keyword Rejection In Subword Based Speech Recognition.” In this patent, the threshold is a preset value, and the value is related to two false rates, including a false alarm rate and a false reject rate. The system manufacturer may perform adjustment by itself and find a balance therein between. In the method of the invention, at least a recognition object and an expected utterance verification result (such as a false alarm rate or a false reject rate) are used as a basis for obtaining the corresponding threshold. Manual adjustment by the user is not required.

Another U.S. patent, U.S. Pat. No. 5,737,489, provides “Discriminative Utterance Verification For Connected Digits Recognition,” and further specifies that the threshold may be dynamically calculated by collecting data online, thereby solving the problem of configuring the threshold when the external environment changes. Although this patent provides a method for calculating the threshold, the method for collecting data online in this patent is as follows. During speech recognition and operation of the utterance verification system, testing data of the new environment is used to obtain the recognition result through speech recognition. After analysis of the recognition result, the previously configured threshold for utterance verification is updated.

In summary of various prior art, the most common method is finding the optimal threshold through collecting additional data, and the second most common method is letting the user configuring the threshold by himself or herself The above methods, however, are more or less the same in that a recognition result in a new environment is obtained through speech recognition, an existing term is verified after analysis of the result, and the threshold is updated.

### SUMMARY

The disclosure provides an apparatus for generating a threshold for utterance verification which is suitable for a speech recognition system. The apparatus for generating the threshold for utterance verification includes a value calculation module, a object score generator, and a threshold determiner. The value calculation module is configured to generate a plurality of values corresponding to a plurality of speech segments. The object score generator receives a sequence of speech unit of at least one of the recognition objects, and generates at least one value distribution from the values corresponding to the sequence of speech unit selected form the value calculation module. The threshold determiner is configured to receive the value distribution, and to generate a recommended threshold according to an expected utterance verification result and the value distribution.

The disclosure provides a method for generating a threshold for utterance verification which is suitable for a speech recognition system. In the method, a plurality of values corresponding to a plurality of speech units are generated and stored. A speech unit sequence of at least one recognition object is received, and a value distribution is generated from the values corresponding to the speech unit sequence. A recommended threshold is generated according to an expected utterance verification result and the value distribution.

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic framework diagram of a conventional speech recognition system.

FIGS. 1B and 1C are each a schematic diagram of a method for generating or adjusting a threshold in the speech recognition system in FIG. 1A.

FIG. 2 is a schematic flowchart of processing an integrated circuit which has a speech recognition function from a manufacturer to a system integrator.

FIG. 3 is a schematic diagram of a method for automatically calculating a threshold for utterance verification according to an embodiment of the disclosure.

FIG. 4A is a schematic block diagram of a speech recognition system according to an embodiment of the disclosure.

FIG. 4B is a schematic diagram of an utterance verificator performing a hypothesis testing method on a term.

FIG. 5 is a schematic block diagram of an utterance verification threshold generator according to an embodiment of the disclosure.

FIG. 6A is a schematic block diagram of an implementation of a value calculation module according to an embodiment of the disclosure, and FIG. 6B is a schematic diagram of generating values.

FIG. 7 is a schematic diagram illustrating how a data stored in a speech unit score statistic database is used in a hypothesis testing method.

FIGS. 8A to 8E are each a test result diagram of a method for automatically calculating the threshold for utterance verification according to an embodiment of the disclosure.

FIG. 9 is a schematic diagram illustrating an utterance verification threshold generator being used with the utterance verificator according to an embodiment of the disclosure.

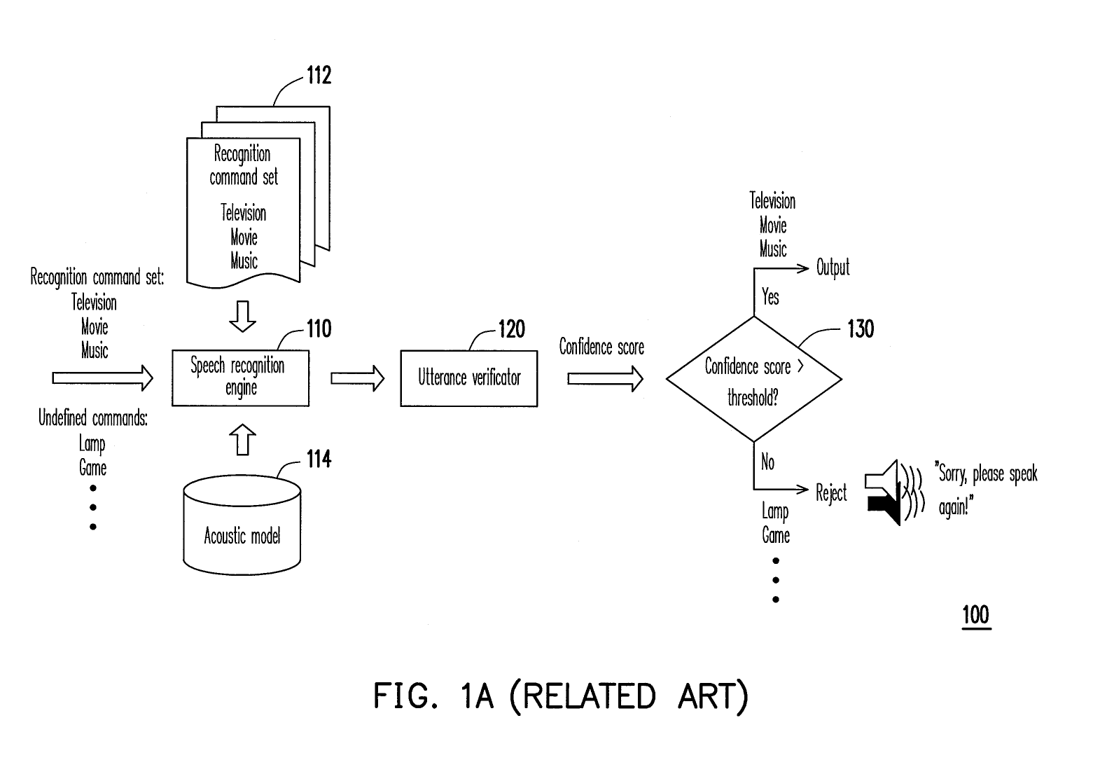

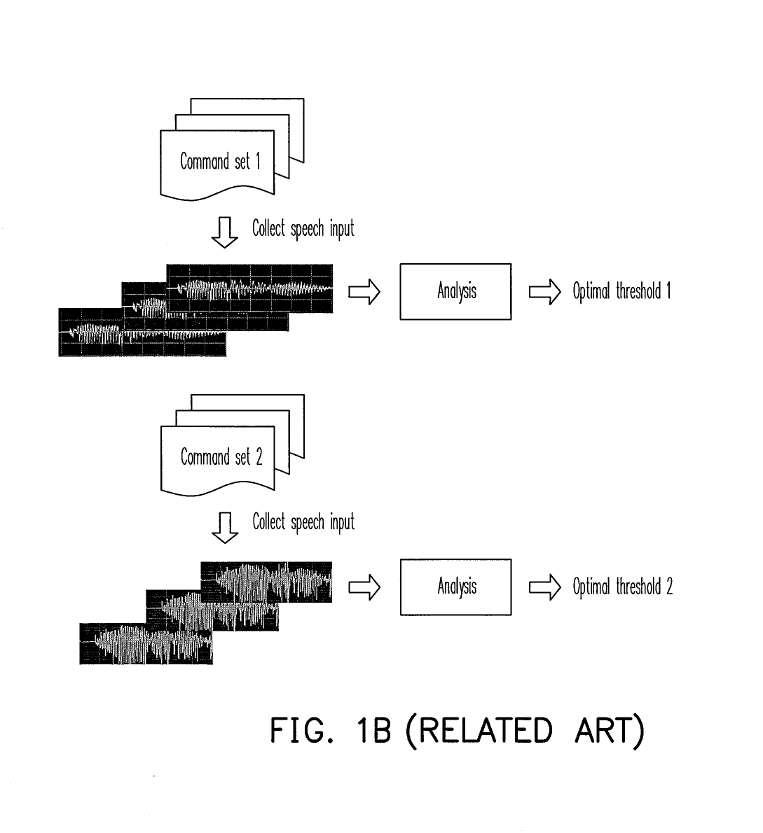

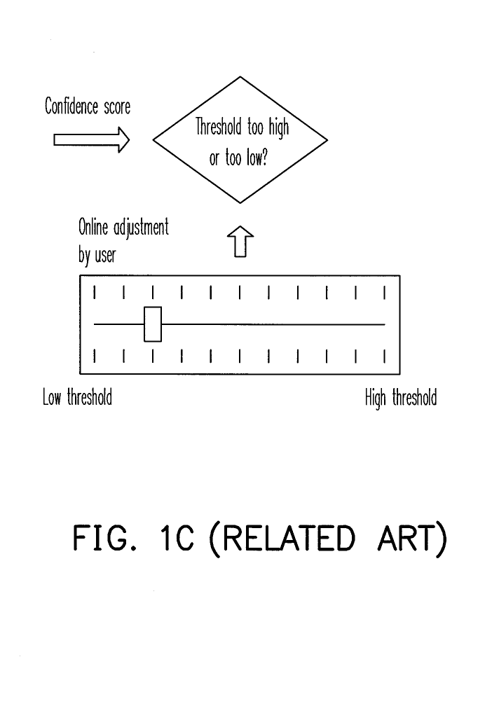

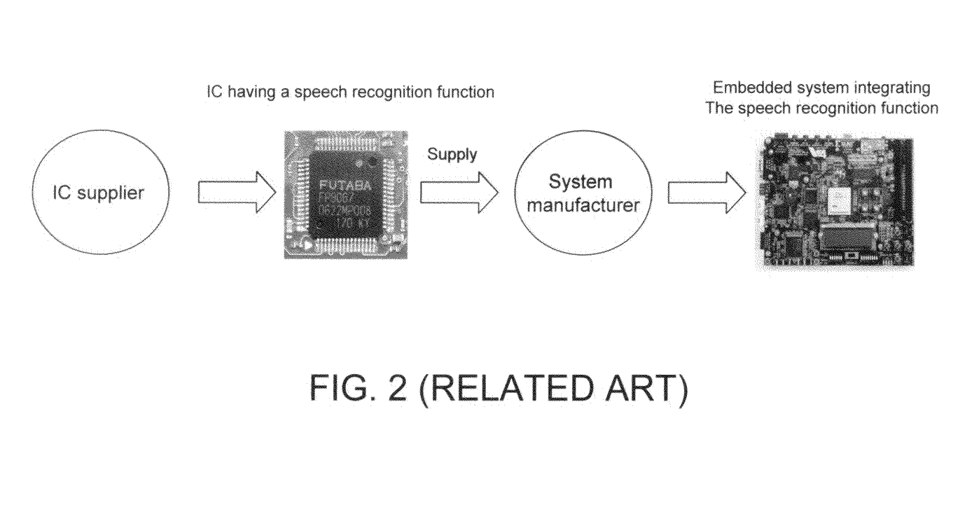

### DETAILED DESCRIPTION OF DISCLOSED EMBODIMENTS

A method of calculating a threshold for utterance verification is introduced herein. When a recognition object is determined, a recommended threshold is obtained according to an expected utterance verification result. In addition, extra collection of corpuses or training models is not necessary for the utterance verification introduced here.

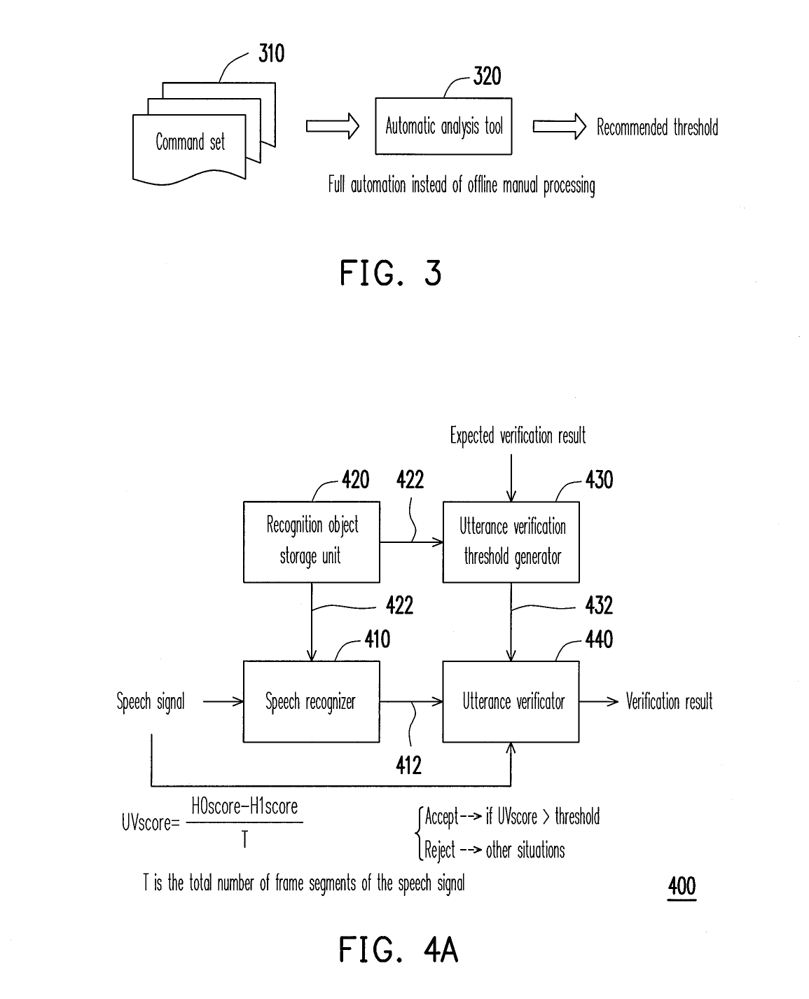

Please refer to FIG. 3. When the recognition object is determined as a command set 310, a recommendation threshold is obtained through analysis according to a preset criteria by an automatic analysis tool 320 and using an automatic processing method instead of a manual offline processing method. The embodiment is different from the manner such as obtaining a recognition result in a new environment through speech recognition, verifying an existing term after analysis of the result, and updating the threshold. According to the embodiment, before the speech recognition system starts to operate, adjustment of effects of utterance verification are performed on the specific recognition objects, so that the recommended threshold is dynamically obtained. The recommended threshold is output to the utterance verificator for rendering a judgment, so as to obtain a verification result.

For companies in the field of integrated circuit design, the method according to the embodiment provides solutions for speech recognition, so that downstream manufacturers are able to develop speech recognition related products rapidly and efficiently and do not have to worry about the problem of collecting corpuses. The above method is considerably beneficial to the promotion of speech recognition technology.

According to the embodiment, before the operations of speech recognition and utterance verification, the threshold for utterance verification of the recognition object is predicted. In the related art, however, an existing threshold is used, and afterwards, when the speech recognition system and the utterance verification module are operated, the existing threshold is updated while corpuses are collected simultaneously. Hence, the related art is significantly different from the implementation of the disclosure. Additionally, it is not necessary to collect data for analysis during the operations of the speech recognition system and the utterance verification system, instead, an existing speech data is used. The existing speech data may be obtained from many resources, for example, a training corpus of the speech recognition system or the utterance verification system. In the method of the disclosure, the threshold for utterance verification is calculated through statistical analysis after the recognition object is determined and before the speech recognition system or the utterance verificator operates, and no extra collection of data is necessary, so that the disclosure is clearly different from the related art.

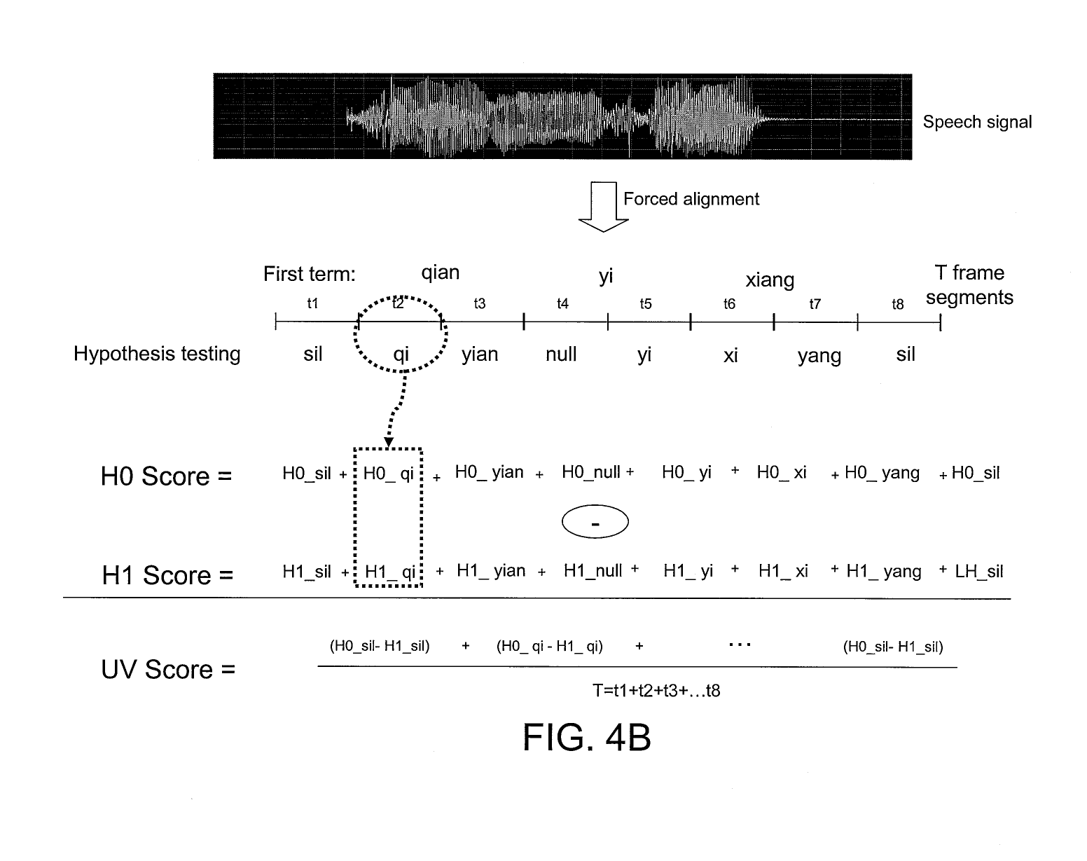

Please refer to FIG. 4A, which is a schematic block diagram of a speech recognition system according to an embodiment of the disclosure. The speech recognition system 400 includes a speech recognizer 410, a recognition object storage unit 420, an utterance verification threshold generator 430, and an utterance verificator 440. An input speech signal is transmitted to the speech recognizer 410 and the utterance verificator 440. The recognition object storage unit 420 stores various sorts of recognition objects to be output to the speech recognizer 410 and the utterance verification threshold generator 430.

The speech recognizer 410 performs recognition according to the received speech signal and a recognition object 422, and then outputs a recognition result 412 to the utterance verificator 440. At the same time, the utterance verification threshold generator 430 generates a threshold 432 corresponding to the recognition object 422 and outputs the threshold 432 to the utterance verificator 440. The utterance verificator 440 performs verification according to the recognition result 412 and the threshold 432, so as to verify whether the recognition result 412 is correct, that is, whether the utterance verification score is greater than the threshold 432.

The recognition object for the speech recognizer 410, in the embodiment, is an existing vocabulary set (such as N sets of Chinese terms) which is capable of being read by the recognition object storage unit 420. After the speech signal passes through the speech recognizer 410, the recognition result is transmitted to the utterance verificator 440.

On the other hand, the recognition object is also input into the utterance verification threshold generator 430, and an expected utterance verification result, such as a 10% false reject rate, is provided, so as to obtain a recommended threshold θ_{UV}.

In the utterance verification threshold generator 430, according to an embodiment, a hypothesis testing method which is used in statistical analysis may be used to calculate an utterance verification score. The disclosure, however, is not limited to using said method.

There is a null hypothesis model and a alternative hypothesis model (respectively represented by H0 and H1) for each of the speech units. After converting the recognition result into a speech unit sequence, by using the corresponding null hypothesis models and the alternative hypothesis models, a null and a alternative hypothesis verification score for each of the units are calculated and added, so as to obtain a null hypothesis verification score (H0 score) and a alternative hypothesis verification score (H1 score) of the whole speech unit sequence. An utterance verification score (UV score) is then obtained through the following equation.

$$UV score = \frac{H 0 score - H 1 score}{T}$$

T represents the total number of frame segments of the speech signal

Finally, the utterance verification score (UV score) is compared with the threshold θ_{UV}. If the UV score is greater than θ_{UV}, verification is successful and the recognition result is output.

For the following embodiment, please refer to FIG. 4B, which is a schematic diagram of the utterance verificator 440 performing a hypothesis testing method on the term “qian yi xiang,” which means “the previous item” in Chinese. Under the premise that there are eight frame segments t1 to t8 which respectively correspond to eight hypothesis testing segments, the speech signal is aligned with these eight frame segments through a forced alignment method and is divided into speech units “sil” (representing silence), “qi,” “yi,” “an,” “null,” “yi,” “xi,” “yang” and “sil.” For each of the speech units, a null and a alternative hypothesis verification score are calculated. For example, H0_sil and H1_sil, H0_qi and H1_qi, H0_yi and H1_yi, H0_an and H1_an, H0_null and H1_null, H0_yi and H1_yi, H0_xi and H1_xi, H0_yang and H1_yang, and H0_sil and H1_sil, as shown in FIG. 4B.

Last, the scores are respectively added to obtain a null hypothesis verification score (H0 score) and alternative hypothesis verification score (H1 score) of the whole speech unit sequence, so as to obtain the utterance verification score (UV score).

$$UV score = \frac{( H 0 \_sil - H 1 \_sil ) + ( H 0 \_qi - H 1 \_qi ) + … + ( H 0 \_sil - H 1 \_sil )}{T = t 1 + t 2 + t 3 + t 4 + t 5 + t 6 + t 7 + t 8}$$

T represents the total number of frame segments of the speech signal

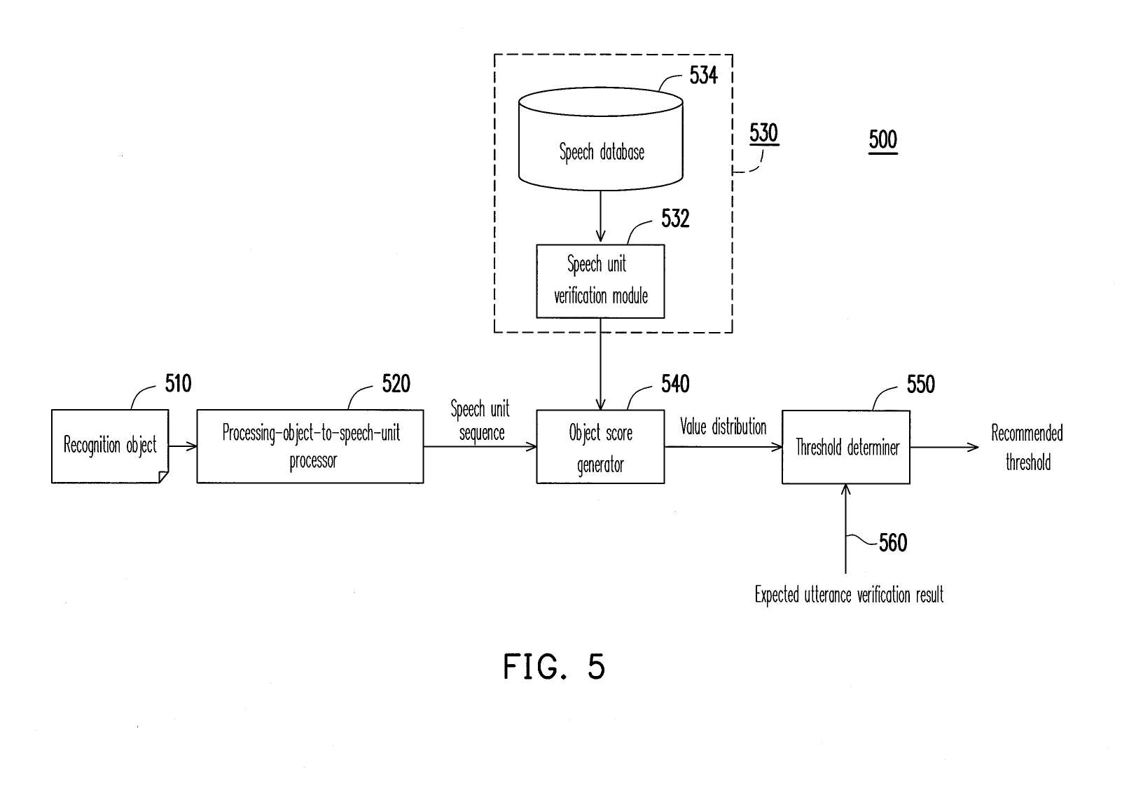

The above utterance verification threshold generator is shown, for example, as a block diagram in FIG. 5 according to an embodiment of the disclosure.

The utterance verification threshold generator 500 includes a processing-object-to-speech-unit processor 520, an object score generator 540, and a threshold determiner 550. The utterance verification threshold generator 500 further includes a value calculation module 530. The value calculation module 530 is used to generate values to be provided to the object score generator 540. According to an embodiment, the value calculation module 530 includes a speech unit verification module 532 and a speech database 534. The speech database 534 is used to store an existing corpus and may be a database having training corpuses or a storage medium into which a user inputs relevant training corpuses. The stored data may be an original audio file, a speech character parameter, or the like. The original audio file is, for example, a file in RAW AUDIO FORMAT® (RAW), WAVEFORM AUDIO FILE FORMAT® (WAV), or AUDIO INTERCHANGE FILE FORMAT® (AIFF). The speech unit verification module 532 calculates the speech verification scores of each of the speech units from the speech database 534 and provides the utterance verification scores as one or more values to the object score generator 540.

According to the speech unit sequence which is received and according to the one or more values of each of the speech units corresponding to the speech unit sequence which are received from the value calculation module 530, the object score generator 540 generates a value distribution corresponding to the speech unit sequence and provides the value distribution to the threshold determiner 550.

According to an expected utterance verification result 560 and the value distribution which is received, the threshold determiner 550 generates the recommended threshold and outputs the recommended threshold. According to an embodiment, for example, a 10% false reject rate is given. The threshold determiner 550 determines a value in the value distribution corresponding to the expected utterance verification result and outputs said corresponding value as the recommended threshold.

The value calculation module 530 collects a plurality of score samples corresponding to one of the speech units. For example, X score samples are stored for the speech unit phoᵢ, and the corresponding values are also stored. Here the above embodiment which adopts the hypothesis testing method is used as the preferred embodiment, but the disclosure is not limited to using the hypothesis testing method.

For the speech unit phoᵢ, there are a null hypothesis and a alternative hypothesis verification score (respectively represented by H0score and H1score) for each different sample.

$$\{ \begin{matrix}[ H 0 {score}_{pho i , sample 1} , H 1 {score}_{pho i , sample 1} , {T}_{pho i , sample 1} ] \\ [ H 0 {score}_{pho i , sample 2} , H 1 {score}_{pho i , sample 2} , {T}_{pho i , sample 2} ] \\ ⋮ \\ [ H 0 {score}_{pho i , sampleX} , H 1 {score}_{pho i , sampleX} , {T}_{pho i , sampleX} ]\end{matrix} \}$$

H0 score_{pho i,sample 1} represents the first null hypothesis score sample of phoᵢ, H1 score_{pho i,sample 1} represents the first alternative hypothesis score sample of phoᵢ, and T_{pho i,sample 1} represents the length of frame segment of the first sample of phoᵢ.

After the utterance verification threshold value generator 500 receives the recognition object (assuming that there are W Chinese terms), all the terms are processed through a Chinese term-to-speech unit process of the processing-object-to-speech-unit processor 520, so that the terms are converted into the speech unit sequence Seqᵢ={pho₁, . . . , phoₖ}, wherein i represents the i^{th} Chinese term, and k is the number of speech units of the i^{th} Chinese term.

Next, the speech unit sequence is input into the object score generator 540.

According to the content of the speech unit sequence, the verification scores of the corresponding null hypothesis model and alternative hypothesis model are selected from the value calculation module 530 based on a selection method (such as random selection). The scores are combined by the object score generator 540 into a score sample x of the speech unit sequence according to the following equation.

$$x = \frac{H 0 {score}_{sample} - H 1 {score}_{sample}}{{T}_{sample}} ,$$

H0scoreₛₐₘₚₗₑ=H0scoreₚₕₒ_{₁}_{,sample N}+ . . . +H0scoreₚₕₒ_{ₖ}_{,sample M}

H1scoreₛₐₘₚₗₑ=H1scoreₚₕₒ_{₁}_{,sample N}+ . . . +H1scoreₚₕₒ_{ₖ}_{,sample M}

Tₛₐₘₚₗₑ=Tₚₕₒ_{₁}_{,sample N}+ . . . +Tₚₕₒ_{ₖ}_{,sample M}

H0scoreₚₕₒ_{₁}_{,sample N} and H1scoreₚₕₒ_{₁}_{,sample N} respectively

represent the N^{th} H0 and H1 score samples selected for the first speech unit pho₁ by the value calculation module 530. H0score_{pho k,sample M} [symbol] H1scoreₚₕₒ_{_{K}}_{,sample M} Equally, H0score_{pho k,sample M} and H1scoreₚₕₒ_{_{K}}_{,sample M} respectively represent the M^{th} H0 and H1 score samples selected for the k^{th} speech unit phoₖ from the database of the system.

For each Chinese word, P utterance verification scores (UV scores) {x₁, x₂ . . . , xₚ} are generated as the score sample set for the word, and all the score samples of all the words are combined into a score set for the whole recognition object. The score set for the recognition object is then input into the threshold determiner 550.

In the threshold determiner 550, the score set of the whole recognition object as a whole is statistically analyzed in a histogram and converted into a cumulative rate distribution, so that the threshold θ_{UV} is obtained from the cumulative probability distribution. For example, the threshold when the cumulative probability value is 0.1 is obtained.

According to the above embodiment, the value calculation module 530 may be implemented through the speech unit verification module 532 and the speech database 534. Such an implementation is an embodiment of real-time calculation. Adoption of any technology having an utterance verification function by the value calculation module 530 is within the scope of the disclosure. For example, the technologies disclosed in Taiwan Patent Application Publication No. 200421261, which titled “Utterance verification Method and System”, or “Confidence measures for speech recognition: 200421261 or in the publication “Confidence measures for speech recognition: A survey” by Hui Jiang, Speech communication, 2005 may be used in the value calculation module 530, but not limit thereto. According to another embodiment, a speech unit score database may be adopted, and corresponding scores may be directly selected. The disclosure, however, is not limited to using the speech unit score database. The values stored in the speech unit score database are generated by receiving an existing speech data, generating corresponding scores through speech segmentation and through the speech unit score generator, and storing the scores in the speech unit score database. The following illustrates an embodiment of the above.

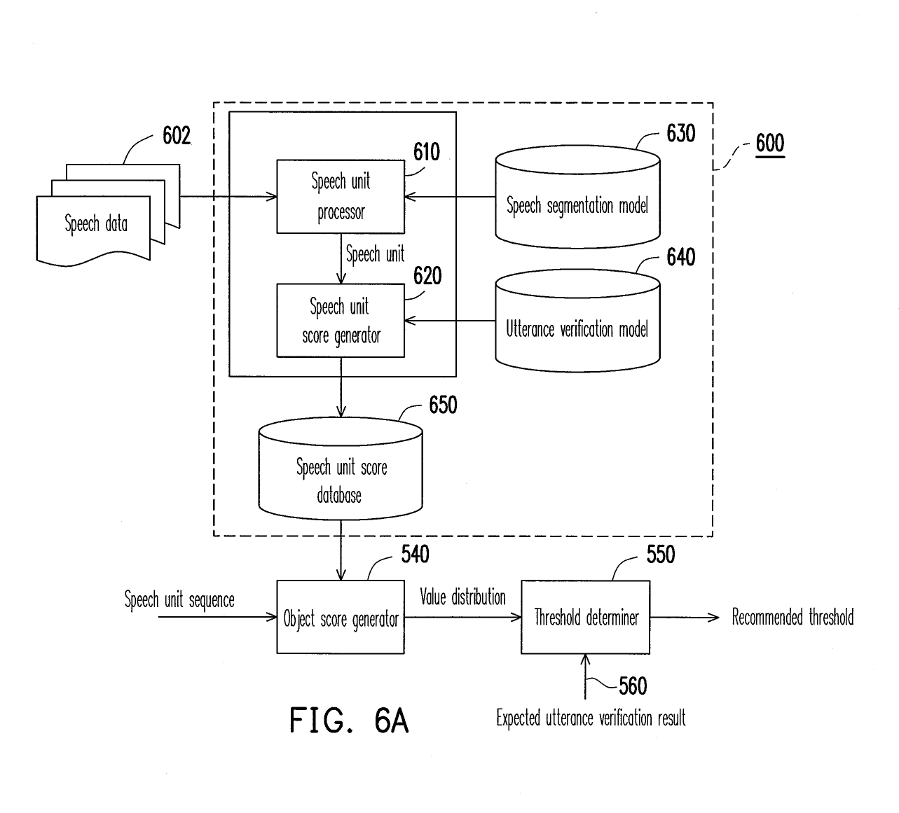

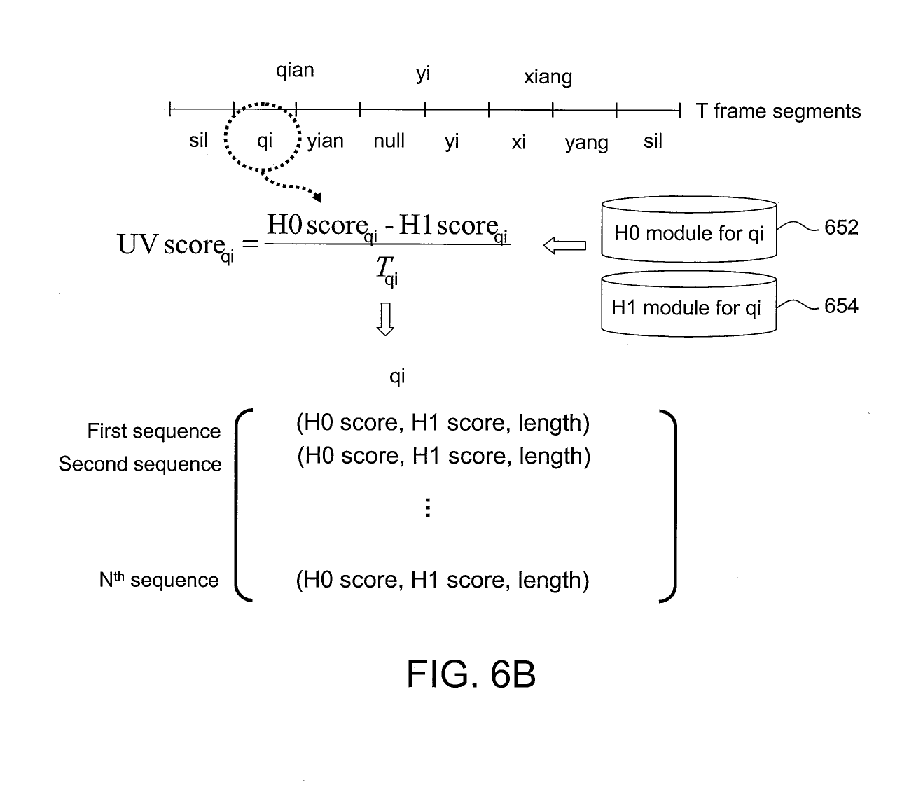

Please refer to FIGS. 6A and 6B, which are each a schematic diagram of an implementation of the value calculation module. FIG. 6A is a schematic block diagram of an implementation of the value calculation module, and FIG. 6B is a schematic diagram of generating values. A value calculation module 600 includes a speech segmentation processor 610 and a speech unit score generator 620. After the speech signal is processed, the data is output to the speech unit score statistic database 650.

A speech data 602 used as the training corpus may be obtained from an existing available speech database. For example, the 500-PEOPLE TRSC (TELEPHONE READ SPEECH CORPUS) PHONETIC DATABASE® or the SHANGHAI MANDARIN ELDA FDB 1000 PHONETIC DATABASE® is one of the sources that may be used.

By using such a framework, after the recognition object is confirmed, the recommended threshold is obtained according to the expected utterance verification result. In addition, extra collection of a corpus or a training model is not necessary for the utterance verification introduced here. The present embodiment does not require obtaining a recognition result in a new environment through speech recognition, verifying an existing term after analysis of the result, and updating the threshold. According to the present embodiment, before the speech recognition system starts to operate, adjustment of effects of utterance verification are performed according to the specific recognition objects, so that a recommended threshold is dynamically obtained. The recommended threshold is output for determination by the utterance verificator, so as to obtain a verification result. For integrated circuit designing companies, the method according to the present embodiment provides more complete solutions for speech recognition, so that downstream manufacturers are able to develop speech recognition related products rapidly and do not have to worry about the problem of collecting corpuses. The above method is considerably beneficial to the promotion of speech recognition technologies.

In the method, first, the speech data 602 is converted into a plurality of speech units by the speech segmentation processor 610. According to an embodiment, the speech segmentation model 630 is the same as the model used by the utterance verificator when performing forced alignment.

Next, the scores corresponding to each of the speech units are obtained after calculation by the speech unit score generator 620. In the above speech unit score generator 620, the scores are generate through an utterance verification model 640. The utterance verification model 640 is the same as the utterance verification model used in the recognition system. The components of the speech unit score in the speech unit score generator 620 may vary according to the utterance verification method used in the speech recognition system. For example, according to an embodiment, when the utterance verification method is a hypothesis testing method, the speech unit score in the speech unit score generator 620 includes a null hypothesis score which is calculated using the corresponding null hypothesis model of said speech unit, and a alternative hypothesis score which is calculated using the corresponding alternative hypothesis model of said speech unit. According to another embodiment, the null and alternative hypothesis scores of each of the speech units are stored, along with the lengths of the units, in the speech unit score statistic database 650. The above may be defined as a first type of implementation. According to another embodiment, for the null and alternative hypothesis scores of each of the speech units, only the statistical value of the differences in each pair of normalized null and alternative hypothesis scores and the statistical values of the lengths are stored. For example, only the mean and the variance are stored in the speech unit score statistic database 650. The above may be defined as a second type of implementation.

According to a different utterance verification method, the score of one of speech units may include a null hypothesis score calculated from said one speech unit through a null hypothesis model of said one speech unit, and may also include a plurality of competing scores calculated in the speech database from all the units except said one unit through the null hypothesis model of said one speech unit. For each of the units, the null hypothesis scores and the corresponding competing null hypothesis scores are stored, along with the lengths of the units, into the speech unit score statistic database 650. The above may be defined as a third type of implementation, wherein a subset or all of the corresponding competing null hypothesis scores may be stored. Alternatively, the statistical value of the differences between the above normalized null hypothesis score and the plurality of competing null hypothesis scores thereof and the statistical value of the lengths may be stored. Said statistical values may be obtained by calculation through a mathematical algorithm. For example, the mean and the variance may be stored, wherein the mathematical algorithm is for calculating the arithmetic mean and the geometric mean. The statistical values are stored into the speech unit score statistic database 650. The above may be defined as a fourth type of implementation.

The calculation method used in the object score generator 540 in FIG. 5 may differ according to the varying content stored in the speech unit score statistic database 650. When the values stored in the speech unit score statistic database 650 are in accordance with the first or third implementation, a distribution of the scores of the speech unit sequence are formed according to sample scores which are generated by randomly selecting from the speech unit score statistic database 650 according to the content of the speech unit sequence. When the values stored in the speech unit score statistic database 650 are in accordance with the second or fourth implementation, the mean and the variance of the distribution of the scores of speech unit sequence are formed according to the content of the speech unit sequence through calculation and combination of the mean and the variance in the speech unit score statistic database 650.

Referring to FIG. 6B, the following describes a calculation method according to an embodiment. Please refer to FIG. 6B. In the hypothesis testing method performed on the term “qian yi xiang,” which means “the previous item” in Chinese, the UV score of the speech unit “qi” is obtained as follows by a null hypothesis model (H0) 652 and a null hypothesis model (H1) 654 of the speech unit “qi”.

$$UV {score}_{qi} = \frac{H 0 {score}_{qi} - H 1 {score}_{qi}}{{T}_{qi}} ,$$

After each of the speech units is processed by the speech unit score generator 620, the utterance verification model 640 is used to calculate the null hypothesis scores (H0) and the null hypothesis scores (H1) thereof, which are stored, along with the lengths of the speech units, into the speech unit score statistic database 650.

$$\{ \begin{matrix}The first sequence [ H 0 score , H 1 score , length ] \\ The second sequence [ H 0 score , H 1 score , length ] \\ ⋮ \\ The Nth sequence [ H 0 score , H 1 score , length ]\end{matrix} \}$$

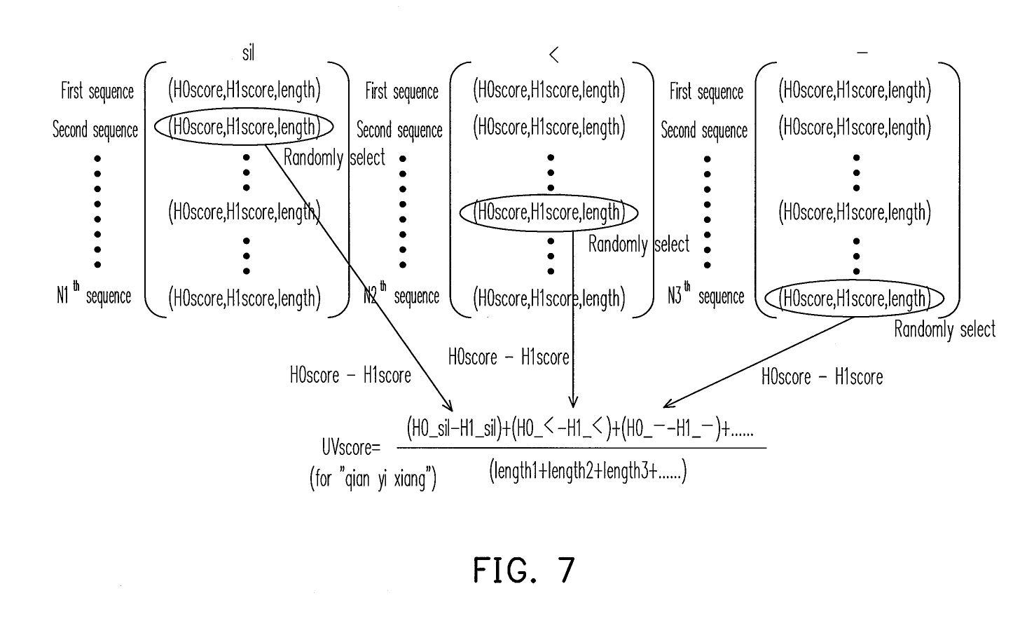

Please refer to FIG. 7, which is a schematic diagram illustrating how the data stored in the speech unit score statistic database is used to form a sample score using the hypothesis testing method. As shown in FIG. 7, the speech unit “sil,” “qi,” and “yi” of the term “qian yi xiang” are used as an example. The disclosure, however, is not limited to the above. Each of speech units may correspond to different speech unit sequences. For example, the speech unit “sil” corresponds to a first sequence to an N1^{th} sequence, the speech unit “qi” corresponds to another first sequence to an N2^{nd} sequence, and the speech unit “yi” corresponds to still another first sequence to an N3^{rd} sequence.

During calculation of the UV score, one of the corresponding speech unit sequences is randomly selected as the basis for calculation. Said one speech unit sequence includes a null hypothesis score (H0), a alternative hypothesis score (H1), and the length of the speech unit. Last, the scores are added to obtain a null hypothesis verification score (H0 score) and alternative hypothesis verification score (H1 score), so as to obtain the utterance verification score (UV score).

$$UV score = \frac{( H 0 \_sil - H 1 \_sil ) + ( H 0 \_qi - H 1 \_qi ) + ( H 0 \_yi - H 1 \_yi ) + …}{T = length 1 + length 2 + length 3 + …}$$

T is the total number of frame segments of the term “qian yi xiang”

Next, the following provides a plurality of actual experimental examples for description.

An existing speech database is used for verification. Here, the 500-PEOPLE TRSC (TELEPHONE READ SPEECH CORPUS) PHONETIC DATABASE® is used as an example. From the TRSC DATABASE®, 9006 sentences are selected as the training corpus for the speech segmentation model and the utterance verification model (please refer to the speech segmentation model 630 and the utterance verification model 640 in FIG. 6A). By following a flowchart such as the one in FIG. 6A, speech segmentation and generation of the scores of the speech units are performed (please refer to the operations of the speech segmentation processor 610 and the speech unit score generator 620 in FIG. 6A), and the speech unit score database is generated.

A simulated testing speech data is selected from the SHANGHAI MANDARIN ELDA FDB 1000 SPEECH DATABASE®. Three testing vocabulary sets are selected in total.

The testing vocabulary set (1) includes five terms “qian yi xiang” (meaning “the previous item” in Chinese), “xun xi he” (meaning “message box”), “jie xian yuan” (meaning “operator”), “ying da she bei” (meaning “answering equipment”), and “jin ji dian hua” (meaning “emergency phone”) and includes 4865 sentences in total.

The testing vocabulary set (2) includes six terms “jing hao” (meaning “number sign”), “nei bu” (meaning “internal”), “wai bu” (meaning “external”), “da dian hua” (meaning “make a call”), “mu lu” (meaning “index”), and “lie biao” (meaning “list”) and includes 5235 sentences in total.

The testing vocabulary set (3) includes six terms “xiang qian” (meaning “forward”), “hui dian” (meaning “return call”), “shan chu” (meaning “delete”), “gai bian” (meaning “change”), “qu xiao” (meaning “cancel”), and “fu wu” (meaning “service”) and includes 5755 sentences in total.

Each of the three vocabulary sets is operated by, for example, the utterance verification threshold generator shown in FIG. 5. By using the processing-object-to-speech-unit processor 520 and the object score generator 540 in cooperation with the value calculation module 530, the threshold is output by the output determiner 550.

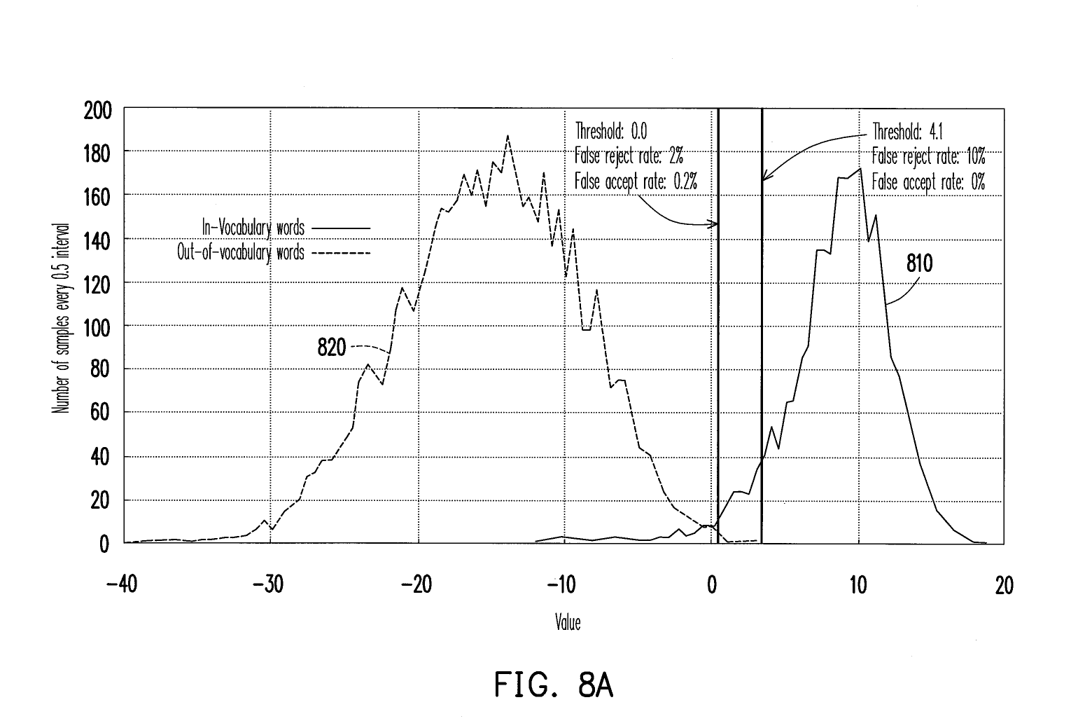

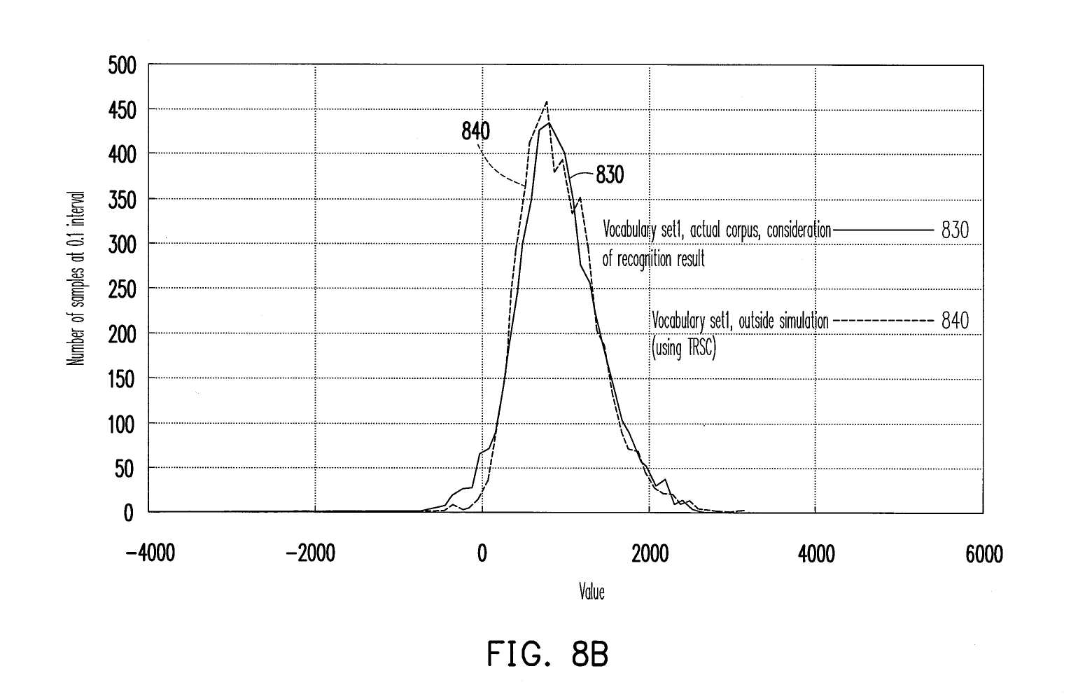

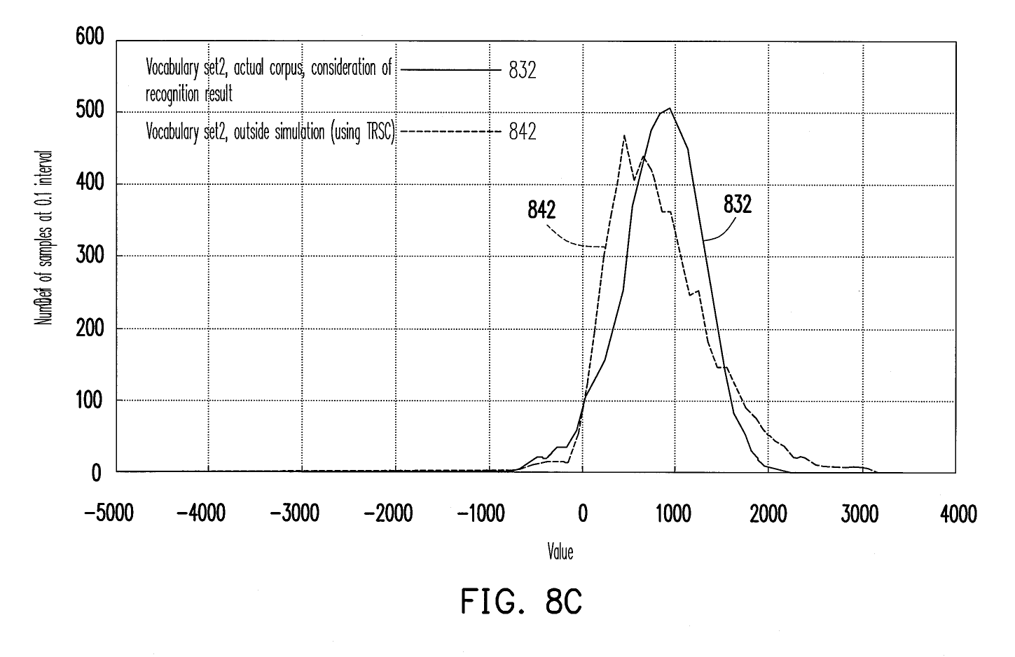

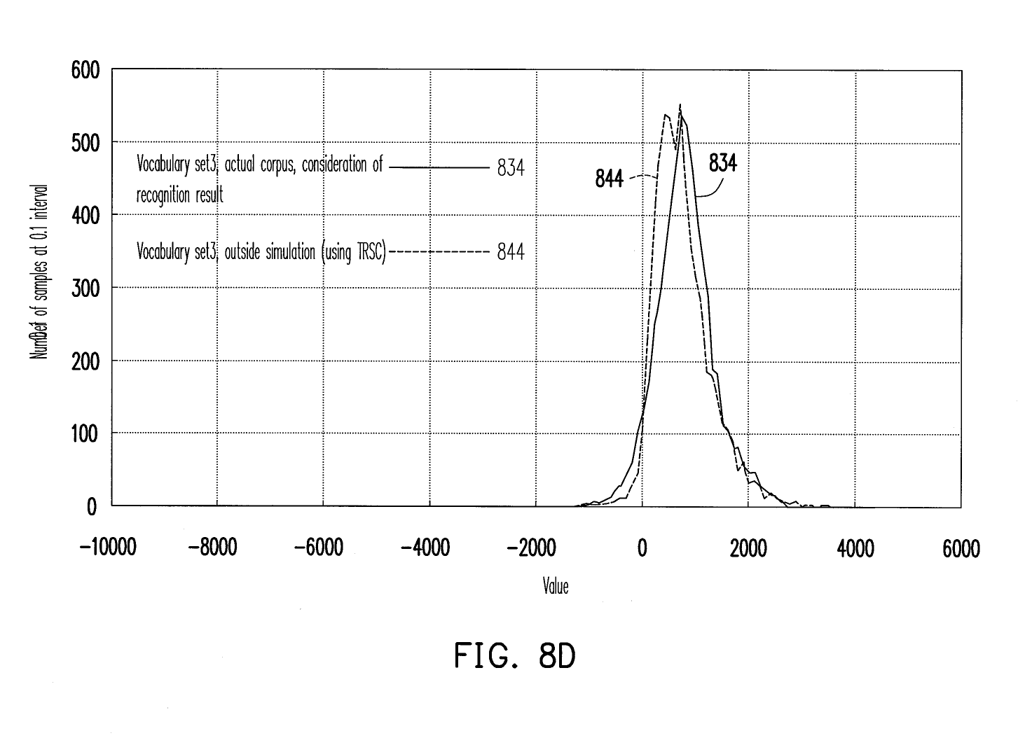

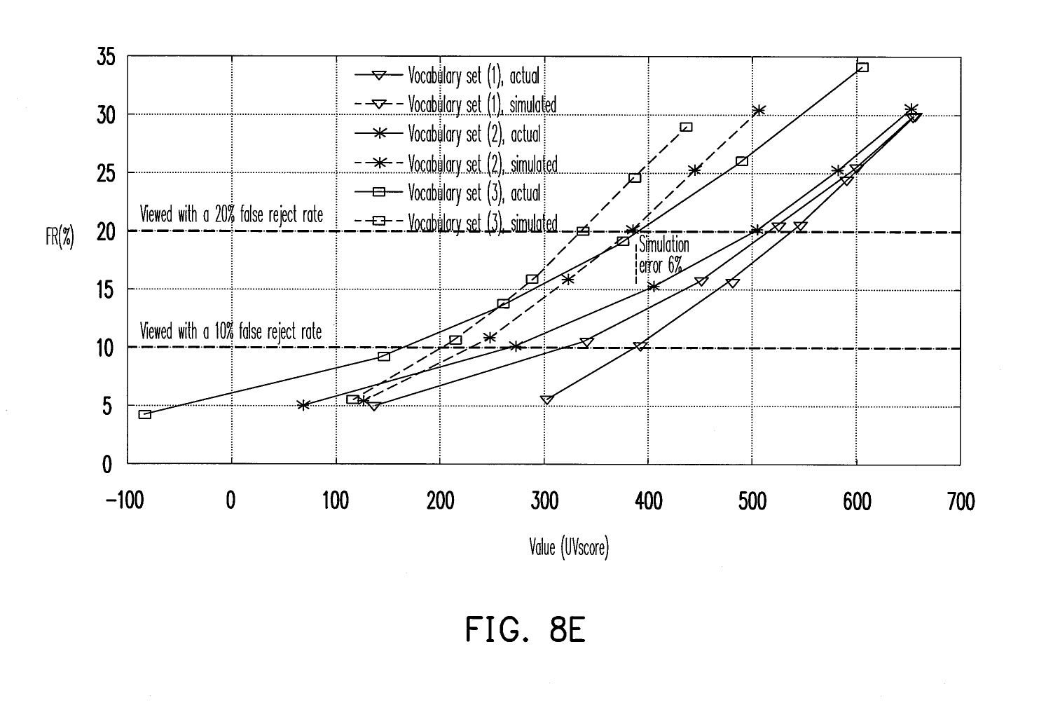

Please refer to FIGS. 8A to 8E for the final results. Referring to FIG. 8A, it is understood that according to requirements of the expected utterance verification result, different thresholds are obtained, and there are different false rejection rates and false alarm rates. The distribution of the utterance verification scores inside the testing vocabulary set is shown by the reference numeral 810 (“In-Vocabulary words”) in FIG. 8A. The distribution is obtained by analyzing the testing corpus. For ease of description, the testing vocabulary set (2) is used for analyzing a distribution of utterance verification scores of out-of-vocabulary terms. Said distribution is shown by the reference numeral 820 (“Out-of-Vocabulary words”, “00V”) in FIG. 8A, wherein the recognition terms of the testing vocabulary set (2) are different from those of the testing vocabulary set (1). For example, when the threshold in FIG. 8A is 0.0, the false reject rate is 2%, and the false alarm rate is 0.2%. Alternatively, when the threshold is 4.1, the false reject rate is 10%, and the false alarm rate is 0%. It is understood from FIG. 8A that according to the distribution 810 of the utterance verification scores of the vocabulary terms, a value on the horizontal axis is selected as the threshold of the verification scores, and the relative false reject rate and false alarm rate are obtained. In fact, by using the above method, the simulated distributions of the utterance verification scores of the vocabulary sets can be produced. By using a histogram to convert the distribution into a cumulative probability distribution, a suitable threshold for the utterance verification scores is obtained therefrom. The cumulative probability corresponding to the threshold and multiplied by 100% is the false reject rates (%).

In FIG. 8B, the solid line indicated by the reference numeral 830 shows a distribution of utterance verification scores calculated through statistical analysis of the testing vocabulary set (1) using an actual testing corpus by the recognizer and the utterance verificator. The broken line indicated by the reference numeral 840 shows a distribution of utterance verification scores simulated by using the above method and using a corpus (such as the above TRSC DATABASE®) not included in the testing corpus set. In FIG. 8C, the solid line indicated by the reference numeral 832 shows a distribution of utterance verification scores calculated through statistical analysis of the testing vocabulary set (2) using an actual testing corpus by the recognizer and the utterance verificator. The broken line indicated by the reference numeral 842 shows a distribution of utterance verification scores simulated by using the above method and using a corpus (such as the above TRSC DATABASE®) not included in the testing corpus set. In FIG. 8D, the solid line indicated by the reference numeral 834 shows a distribution of utterance verification scores calculated through statistical analysis of the testing vocabulary set (3) using an actual testing corpus by the recognizer and the utterance verificator. The broken line indicated by the reference numeral 844 shows a distribution of utterance verification scores simulated by using the above method and using a corpus (such as the above TRSC DATABASE®) not included in the testing corpus set.

As shown in FIG. 8E, by converting each of the results indicated by the different reference numerals 830, 832, 834, 840, 842, 844 into the cumulative probability distributions, three different sets of operational performance curves are obtained according to the utterance verification scores and the false reject rates. The horizontal axis represents the value of the utterance verification scores, and the vertical axis represents the false reject rate (as FR % shown in FIG. 8E). From FIG. 8E, the performance of the three testing vocabulary sets after implementation is shown. The solid lines are the actual operation curve, whereas the broken lines are the simulated operation curve. As understood from FIG. 8E, when the false reject rate is from 0% to 20%, the error rate between the simulated curve and the actual curve of each of the testing vocabulary sets is less than 6%, which is within the acceptable range during real application.

Although the disclosure has been described with reference to the above embodiments, it is apparent to one of the ordinary skill in the art that modifications to the described embodiments may be made without departing from the spirit of the disclosure. Accordingly, the scope of the disclosure will be defined by the attached claims and not by the above detailed descriptions.

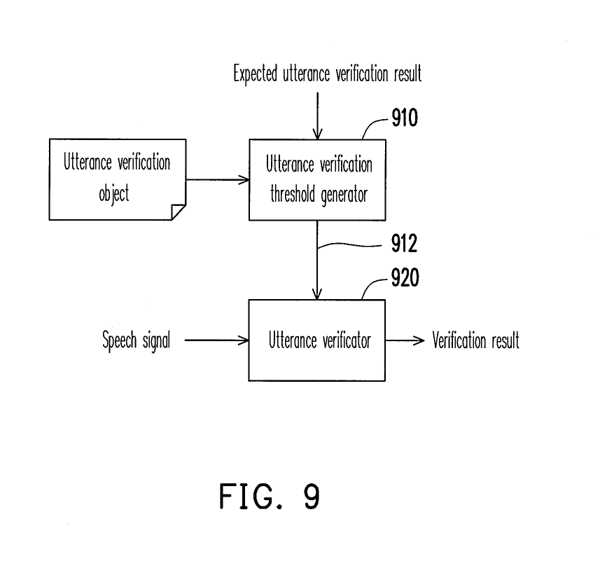

For example, the disclosure may be used alone or with the utterance verificator, as shown in FIG. 9. In FIG. 9, a utterance verification threshold generator 910 generates a recommended threshold 912 to the utterance verificator 920 after receiving an utterance verification object. A speech signal may be input into the utterance verificator to perform utterance verification.

After summarizing the above possible embodiments, the recognition object and the utterance verification object are collectively called the processing object. The utterance verification threshold generator provided by the disclosure is capable of receiving at least one processing object and outputting the at least one recommended threshold corresponding to the at least one processing object.

Hence, the scope of the disclosure is defined by the following claims and their equivalents.

What is claimed is:

1. An apparatus for generating a threshold for utterance verification, the apparatus comprising:
a value calculation module, configured to generate one or plurality of values corresponding to at least one speech unit;
an object score generator, configured to receive at least one speech unit sequence, to obtain the value corresponding to the speech unit in the speech unit sequence from the value calculation module, and to combine the value corresponding to the speech unit sequence into a value distribution; and
a threshold determiner, connected to the object score generator and configured to receive the one or the plurality of value distributions, and to generate a recommended threshold according to an expected utterance verification result and the value distribution.

2. The apparatus for generating the threshold for utterance verification of claim 1, further comprising:
a processor, configured to receive a processing object, to convert the processing object into the speech unit sequence, and to output the speech unit sequence to the object score generator.

3. The apparatus for generating the threshold for utterance verification of claim 1, wherein the object score generator is configured to combine the one or the plurality of values corresponding to the speech unit in the speech unit sequence into the one or the plurality of value distributions corresponding to the speech unit sequence by using a linear combination method.

4. The apparatus for generating the threshold for utterance verification of claim 1, wherein the threshold determiner is configured to correspond an input criteria of the expected utterance verification result to a corresponding value of the value distribution, the corresponding value being the recommended threshold.

5. The apparatus for generating the threshold for utterance verification of claim 4, wherein the input criteria of the expected utterance verification result is a false reject rate.

6. The apparatus for generating the threshold for utterance verification of claim 1, wherein the value calculation module comprises:
a speech database, configured to store one or plurality of speech data corresponding to at least one of the speech units;
a speech unit verification module, configured to receive the one or the plurality of speech data in the speech database, to calculate one or the plurality of verification scores corresponding to the speech unit, and to provide the verification scores to the object score generator as the value.

7. The apparatus for generating the threshold for utterance verification of claim 6, wherein a form of the one or the plurality of speech data stored in the speech database comprises an original audio file or speech characteristic parameters, or comprises both of them.

8. A method for generating a threshold for utterance verification, the method comprising:
calculating one or a plurality of values corresponding to at least one speech unit;
receiving at least one speech unit sequence, obtaining the one or the plurality of values corresponding to the speech unit in the speech unit sequence, and combining the one or the plurality of values corresponding to the speech unit sequence into one or the plurality of value distributions; and
generating a recommended threshold according to an expected utterance verification result and the value distribution.

9. The method for generating the threshold for utterance verification of claim 8, further comprising:
converting a processing object into the speech unit sequence, so that the speech unit sequence is used for obtaining the values corresponding to the speech unit sequence, and the values are combined into the value distribution.

10. The method for generating the threshold for utterance verification of claim 8, wherein after receiving the speech unit sequence, combining the one or the plurality of values corresponding to the speech unit in the speech unit sequence into the one or the plurality of value distributions corresponding to the speech unit sequence by using a linear combination method.

11. The method for generating the threshold for utterance verification of claim 8, wherein an input criteria of the expected utterance verification result is used to be corresponded to a corresponding value of the value distribution, the corresponding value being the recommended threshold.

12. The method for generating the threshold for utterance verification of claim 11, wherein the input criteria of the expected utterance verification result is a false reject rate.

13. The method for generating the threshold for utterance verification of claim 8, wherein the step of calculating the one or the plurality of values corresponding to the speech unit comprises:
calculating one or the plurality of speech data stored in a speech database corresponding to the speech unit, generating the speech unit verification score of the speech unit, and providing the speech unit verification score as the one or the plurality of values.

14. The method for generating the threshold for utterance verification of claim 13, wherein a form of the at least one speech data stored in the speech database comprises one of an original audio file or speech characteristic parameters, or comprises both of them.

15. An system for generating a threshold for utterance verification, the system comprising:
a value calculation module, configured to generate one or a plurality of values corresponding to at least one speech unit;
an object score generating module, configured to receive at least one speech unit sequence, to obtain the one or the plurality of values corresponding to the one or the plurality of the speech units in the speech unit sequence from the value calculation module, and to combine the one or the plurality of values corresponding to the speech unit sequence into one or a plurality of value distributions; and
a threshold determining module, connected to the object score generating module and configured to receive the one or the plurality of value distributions, and to generate a recommended threshold according to an expected utterance verification result and the one or the plurality of value distributions.

16. The system for generating the threshold for utterance verification of claim 15, further comprising:
a processing module, configured to receive a processing object, to convert the processing object into the speech unit sequence, and to output the speech unit sequence to the object score generating module.

17. The system for generating the threshold for utterance verification of claim 15, wherein the object score generating module is configured to combine the one or the plurality of values corresponding to the one or the plurality of speech units in the speech unit sequence into the one or the plurality of value distributions corresponding to the speech unit sequence by using a linear combination method.

18. The system for generating the threshold for utterance verification of claim 15, wherein the threshold determining module is configured to correspond an input criteria of the expected utterance verification result to a corresponding value of the one or the plurality of value distributions, the corresponding value being the recommended threshold.

19. The system for generating the threshold for utterance verification of claim 18, wherein the input criteria of the expected utterance verification result is a false reject rate.

20. The system for generating the threshold for utterance verification of claim 15, wherein the value calculation module comprises:
a speech database, configured to store one or the plurality of speech data corresponding at least one speech unit;
a speech unit verification module, configured to receive the one or the plurality of speech data in the speech database, to calculate the one or the plurality of verification scores corresponding to the one or the plurality of speech units, and to provide the one or the plurality of verification scores to the object score generating module as the one or the plurality of values.

21. The system for generating the threshold for utterance verification of claim 20, wherein a form of the at least one speech data stored in the speech database comprises at least an original audio file or speech characteristic parameters, or comprises both of them.

22. A speech recognition system, comprising the apparatus for generating the threshold for utterance verification of claim 1, the apparatus being configured to generate the recommended threshold, and to enable the speech recognition system to perform verification and to output a verification result.

23. The speech recognition system of claim 22, further comprising:
a speech recognizer, configured to receive a speech signal;
a processing object storage unit, configured to store a plurality of processing objects, wherein the speech recognizer is configured to read the at least one processing object, to render a judgment according to the speech signal and the at least one processing object which is read, and to output a recognition result; and
an utterance verificator, configured to receive the recognition result and the recommended threshold, so as to perform verification and output the verification result accordingly.

24. A speech verification system, comprising the apparatus for generating the threshold for utterance verification of claim 1, the apparatus being configured to generate the recommended threshold, and to enable the speech verification system to perform verification and to output a verification result.

25. The speech verification system of claim 24, further comprising:
a processing object storage unit, configured to store at least one processing object; and
an utterance verificator, configured to receive a speech signal, to read the processing object, to perform verification with the recommended threshold after comparing the speech signal and the processing object which is read, and to output the verification result accordingly.
